(19) United States
(12) Patent Application Publication
(10) Pub. No.: US 2025/0350614 A1
(43) Pub. Date: Nov. 13, 2025

(54) MAINTAINING STABLE UNIFORM RESOURCE LOCATOR VERDICTS WITH INTELLIGENT RECRAWLING

(71) Applicant: Palo Alto Networks, Inc., Santa Clara, CA (US)

(72) Inventors: Shresta Bellary Seetharam, Sunnyvale, CA (US); William Russell Melicher, Sunnyvale, CA (US); Mohamed Yoosuf Mohamed Nabeel, San Jose, CA (US); Oleksii Starov, Sunnyvale, CA (US)

(21) Appl. No.: 18/656,645

(22) Filed: May 7, 2024

(51) Int. Cl. H04L 9/40

(52) U.S. Cl. CPC H04L 63/1425; H04L 63/1416

(57) ABSTRACT

A stable verdict recrawling policy maintains stable stored verdicts for uniform resource locators (URLs) with intelligent recrawling. Based on a malicious stored verdict for a URL, a web crawler initiates the recrawling policy. In a first observation window, a web crawler recrawls the URL at successively more infrequent times to obtain verdicts for the URL. If there are enough benign verdicts after the first observation window, a URL verdict flipping model receives recrawling data as input and outputs a flipping verdict indicating whether to flip the stored verdict from malicious to benign. If the stored verdict is flipped, in a second observation window the web crawler recrawls the URL at successively more infrequent times to obtain verdicts. If there is a malicious verdict in the second observation window, the stored verdict is again flipped from benign to malicious.

### BACKGROUND

The disclosure generally relates to transmission of digital information (e.g., CPC class H04L) and network arrangements, protocols or services for addressing or naming (e.g., subclass H04L 61/00).

Uniform resource locator (URL) filtering is a cybersecurity procedure for managing and restricting access to URLs that exhibit malicious or otherwise suspicious behavior. URL filtering systems can maintain databases of known malicious or suspicious URLs to block. These databases maintain URL categories (e.g., adult content, gaming, social media, etc.) to provide interpretable reasons for why URLs were blocked. URL filtering serves various functions such as increasing worker productivity, preventing secure data leakage, reducing occurrence of phishing attacks, etc.

### BRIEF DESCRIPTION OF THE DRAWINGS

Embodiments of the disclosure may be better understood by referencing the accompanying drawings.

FIG. 1 is a schematic diagram of an example system for maintaining a stable verdict for a URL with intelligent recrawling.

FIG. 2 is an illustrative diagram of applying a stable verdict recrawling policy when a malicious stored verdict is flipped to benign in a first observation window and flipped back to malicious in a second observation window.

FIG. 3 is an illustrative diagram of applying a stable verdict recrawling policy when a malicious stored verdict is maintained in a first observation window.

FIG. 4 is an illustrative diagram of applying a stable verdict recrawling policy when a malicious stored verdict is flipped to benign in a first observation window and the benign stored verdict is maintained in a second observation window.

FIG. 5 is a flowchart of example operations for maintaining a stable verdict for a URL with an intelligent recrawling policy.

FIG. 6 is a flowchart of example operations for using verdicts and recrawling data from a first observation window to determine whether to flip a stored verdict for a URL from malicious to benign.

FIG. 7 is a flowchart of example operations for monitoring a benign stored verdict for a URL in a second observation window.

FIG. 8 depicts an example computer system with a URL flipping model and a web crawling having a stable verdict recrawling policy.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Malicious and benign web page verdicts can be volatile for certain types of attacks and behavioral patterns of malicious attackers. For instance, although a web page that was previously malicious may be cleaned up by an administrator, in some instances the post-clean up web page may be actually benign and safe to visit whereas in other instances the post-clean up web page may be vulnerable and unsafe to visit as it is still prone to malicious attackers who are waiting to reattack. Web pages at parked domains that appear benign may be malicious when hosted in the future, and cloaked web pages may divert from malicious to benign web pages when presented to a crawler. Cybersecurity systems that maintain stable verdicts (i.e., verdicts with persistent accuracy over time) for potentially volatile web pages face a logistical challenge-too frequent recrawling of web pages for updated verdicts wastes resources, whereas leaving a web page verdict for too long renders verdicts stale/inaccurate. Additionally, while maintaining stable verdicts, flipping a malicious stored verdict to a benign stored verdict would be difficult to ascertain due to the possibility of future web page compromise.

The present disclosure proposes a recrawling policy that intelligently recrawls URLs to maintain stable verdicts. Once a malicious stored verdict for a URL is obtained and stored in a malicious URL database for URL filtering, if the URL does not satisfy high confidence benign or malicious indicators, a web crawler initiates the recrawling policy. In a first observation window, the web crawler recrawls the URL at times that are successively more infrequent as the first observation window progresses (e.g., after 1 day, after 2 days, after a week, after 2 weeks, and after 30 days). A URL classification model generates a verdict for the URL at each instance of the recrawling. At the end of the first observation window, a URL verdict flipping model (flipping model) determines whether first verdicts generated in the first observation window satisfy criteria for evaluating the stored verdict of the URL (e.g., if a number of benign verdicts in the first observation window is above a threshold). If the first verdicts satisfy the evaluation criteria, a feature vector generated from data from the recrawling is input to the flipping model to obtain an updated stored verdict as output.

If the verdict for the URL was flipped from malicious to benign in the first observation window, the web crawler begins recrawling the URL in a second observation window consecutive to the first observation window (also at progressively more infrequent times). The URL classification model generates second verdicts from recrawling in the second observation window and, if at any instance there is a malicious verdict, the stored verdict for the URL is instantly flipped from benign back to malicious. The web crawler then waits an additional time window (e.g., 30 days) consecutive to the second observation window before reinitiating the recrawling policy to determine whether to flip the malicious verdict.

If at the end of either the first observation window the malicious stored verdict is maintained or at the end of the second observation window the benign stored verdict, is maintained, the web crawler continues recrawling in longer time windows (e.g., every 30 days) to monitor the URL. This recrawling in longer time windows verifies whether the verdict that was maintained in an observation window is still accurate. Aggressive initial recrawling within each of the observation windows with tapered aggressiveness later on captures volatile web page behavior (e.g., from attacks on vulnerable web pages) early on while not wasting recrawling resources thereafter. Spacing out recrawls after the initially aggressive recrawling results in less flip-flopping of verdicts. The flipping model is trained on ground truth verdicts for previously flipped URLs so that it can accurately evaluate whether to flip the stored verdicts from malicious to benign with higher accuracy than typical models trained to generate initial malicious/benign verdicts.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

A “stored verdict” as used herein refers to a verdict for a URL that indicates whether a URL filtering service should block the URL. Stored verdicts are high confidence verdicts for URLs that can incorporate multiple verdicts from multiple URL classification models, multiple URL scores from third party sources, etc. “Enabling” a stored verdict comprises adding the corresponding URL to a list of URLs blocked by the URL filtering service and “disabling” a stored verdict comprises removing the URL from the list.

### Example Illustrations

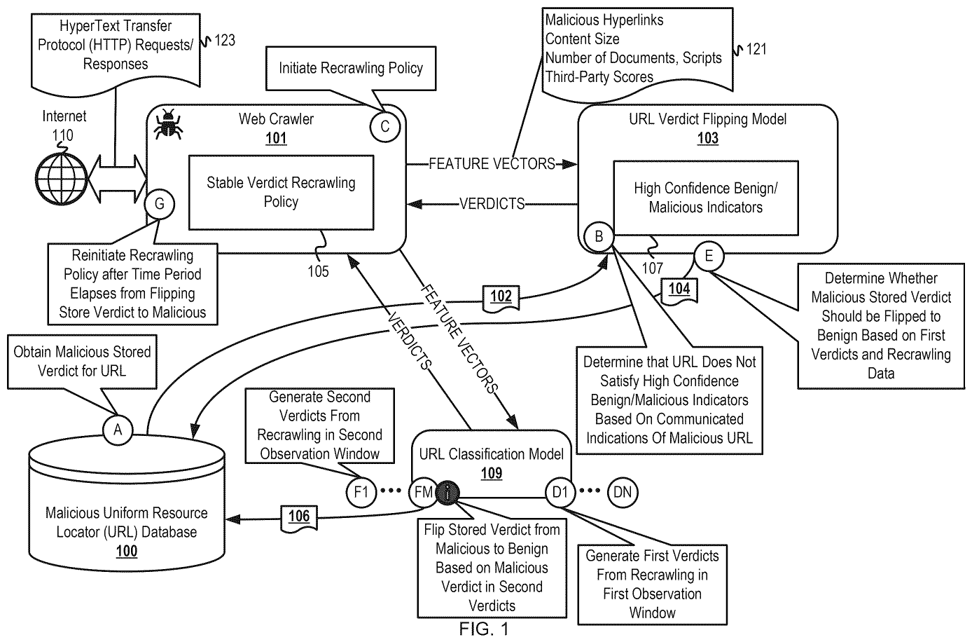

FIG. 1 is a schematic diagram of an example system for maintaining a stable verdict for a URL with intelligent recrawling. The system is depicted with a web crawler 101, a URL classification model 109, a URL verdict flipping model (“flipping model”) 103, and a malicious URL database 100. FIG. 1 is annotated with a series of letters A-C, D1 . . . . DN, E, F1 . . . . FM, and G. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, the malicious URL database 100 obtains a malicious stored verdict for a URL (e.g., from an initial crawl of the URL with the web crawler 101). For instance, the malicious stored URL verdict can be obtained by a cloud firewall service maintaining the malicious URL database 100 for URL filtering. The malicious URL verdict can be obtained based on third party URL services, machine learning models trained to classify malicious or benign URLs, a weighted combination of scores/verdicts from various of these sources, etc.

At stage B, the malicious URL database 100 communicates indications 102 of the malicious stored URL verdict to the flipping model 103. For instance, the indications 102 can comprise the URL corresponding to the malicious stored URL verdict and metadata and/or feature vectors for the URL such as data from a third party oracle source of URLs, categories of the URL, etc. The flipping model 103 compares the indications 102 against high confidence malicious/benign indicators 107 to determine whether the malicious stored verdict is in consideration for flipping. Malicious indicators in the high confidence malicious/benign indicators 107 can comprise risky URL categories (e.g., adult gambling web pages, parked web pages, 404 web pages, empty web pages, etc.), recent malicious behavior associated with the URL from other sources, indications that the URL is associated with phishing attacks, etc. Benign indicators in the high confidence malicious/benign indicators 107 comprise an age of a domain for the URL, a time elapsed since the last change of registration, a stable Internet Protocol (IP) address, a (small) number of known malicious children of the URL, etc. If the indications 102 satisfy any of the malicious indicators, the flipping model 103 determines that the malicious stored verdict is not in consideration for flipping, and the malicious stored verdict for the URL is maintained. If the indications 102 satisfy any of the benign indicators, the flipping model 103 determines that the stored verdict is in fact benign and instructs the malicious URL database 100 to disable or remove the URL. For both cases, the stable verdict recrawling policy 105 is not initiated. In the example depicted in FIG. 1, the URL does not satisfy any of the high confidence malicious/benign indicators 107.

At stage C, the web crawler 101 initiates a stable verdict recrawling policy 105. The web crawler 101 waits an initial window (e.g., 30 days) after receiving the malicious stored verdict before initiating the stable verdict recrawling policy 105. The stable verdict recrawling policy 105 comprises a policy for recrawling in a first observation window to determine whether to flip the stored verdict from malicious to benign. At the end of the first observation window, if the stored verdict was flipped from malicious to benign, then the stable verdict recrawling policy 105 additionally a second observation window for determining whether to flip the stored verdict from benign back to malicious. In each of the first and second observation windows, the stable verdict recrawling policy 105 starts by frequently recrawling and then recrawling becomes more infrequent as the observation windows extend. For instance, the web crawler 101 can recrawl after one day, two days, one week, two weeks, one month, etc. This example of times for recrawling in the observation windows can vary, for instance in terms of the number and frequency of recrawls, the length of the observation windows, different recrawling policies for the first observation window and the second observation window, etc. If, during either observation window, a verdict is maintained, the stable verdict recrawling policy 105 switches to periodic recrawling (e.g., every month) to verify that the stored verdict is still correct.

At stages D1-DN, in the first observation window, the URL classification model 109 generates first verdicts based on crawling in the first observation window. The web crawler 101 crawls the Internet 110 with HyperText Transfer Protocol (HTTP) GET requests in HTTP requests/responses 123 and receives HTTP responses in HTTP requests/responses 123 from the Internet 110. The web crawler 101 generates a feature vector(s) of an HTTP response(s) retrieved from each recrawling and communicates the feature vector(s) to the URL classification model 109 and the URL classification model 109 generates first verdicts for the URL in the first observation window. In contrast to the flipping model 103 which is trained on recrawling data for URLs that were flipped from malicious to benign and corresponding ground truth verdicts, the URL classification model 109 is trained to generate initial verdicts for URLs. For instance, the URL classification model 109 can comprise the model used to generate the initial malicious stored verdict for the URL.

At stage E, at the end of the first observation window, the flipping model 103 determines whether the malicious stored verdict should be flipped to benign based on the first verdicts and recrawling data from the first observation window. Implementations can vary on how the first verdicts are provided to the URL flipping model 103 for evaluation. For instance, first verdicts can be communicated to the URL flipping model 103 after generation from the URL classification model 109 or based on detection of a new verdict being stored in the malicious URL database 100. The flipping model 103 first applies evaluation criteria to the first verdicts of each recrawled URL to determine whether the malicious stored verdict is eligible for flipping. For instance, the evaluation criteria can comprise that all the first verdicts are benign, that a threshold number and/or percentage of the first verdicts are benign, etc. If the first verdicts fail the evaluation criteria, the malicious stored verdict is not eligible for flipping. Otherwise, if the first verdicts satisfy the evaluation criteria, then the flipping model 103 generates a feature vector of the recrawling data and generates a flipping verdict based on inputting the generated feature vector. Example recrawling data 121 comprises malicious hyperlinks in the web page for the URL, content size in the web page, a number of documents and number of scripts in the web page, and third-party oracle source scores for maliciousness of the web page. The flipping verdict indicates whether to flip the stored verdict from malicious to benign. The flipping model 103 can average or otherwise aggregate values for each of these features across recrawls when generating the feature vector to provide a combined perspective of behavior of the URL across the first observation window. For the embodiment depicted in FIG. 1, the flipping model 103 determines that the stored verdict should be flipped from malicious to benign. The flipping model 103 then communicates an indication 104 to the malicious URL database 100 of the benign stored verdict and the malicious URL database 100 disables the URL.

The flipping model 103 comprises a machine learning model trained on recrawling data in observation windows for URLs and corresponding ground truth verdicts that indicate that the URLs switched from malicious to benign in the observation windows or that the URLs stayed malicious in the observation windows. The flipping model 103 is trained to accurately predict when to flip the stored verdict from malicious to benign when the URL was effectively cleaned up during the first observation window and when to not flip the stored verdict when the URL was not effectively cleaned up during the first observation window (e.g., when the web page is benign at the end of the first observation window but could still be compromised in the future). Example machine learning models for the flipping model 103 include a random forest model, a support vector machine, a neural network classifier, etc.

At stages F1-FM, the web crawler 101 recrawls the URL via the Internet 110 in the second observation window according to the stable verdict recrawling policy 105 and the URL classification model 109 generates second verdicts from data of the recrawling. At each of the stages F1-FM, if the URL classification model 109 generates a malicious verdict then the URL classification model 109 immediately communicates an indication 106 to the malicious URL database 100 to enable the URL (depicted at the Mth recrawling iteration in FIG. 1). The criteria for flipping the stored verdict from malicious to benign in the first observation window is much stricter than the criteria for flipping the stored verdict from benign to malicious in the second observation window, resulting in increased resilience to malicious attacks on vulnerable web pages.

At stage G, the web crawler 101 reinitiates the stable verdict recrawling policy 105 after a time window (e.g., 30 days) elapses from flipping the stored verdict for the URL back to malicious. The web crawler 101 allows the time window to elapse to save recrawling resources and because the URL has a higher likelihood of being compromised after a malicious verdict while an administrator or other entity attempts to clean up the URL.

The stable verdict recrawling policy 105 can be integrated into an existing crawling policy for the web crawler 101. For instance, the stable verdict recrawling policy 105 can initialize recrawling policies for URLs in the existing crawling policy when they receive initial malicious stored verdicts.

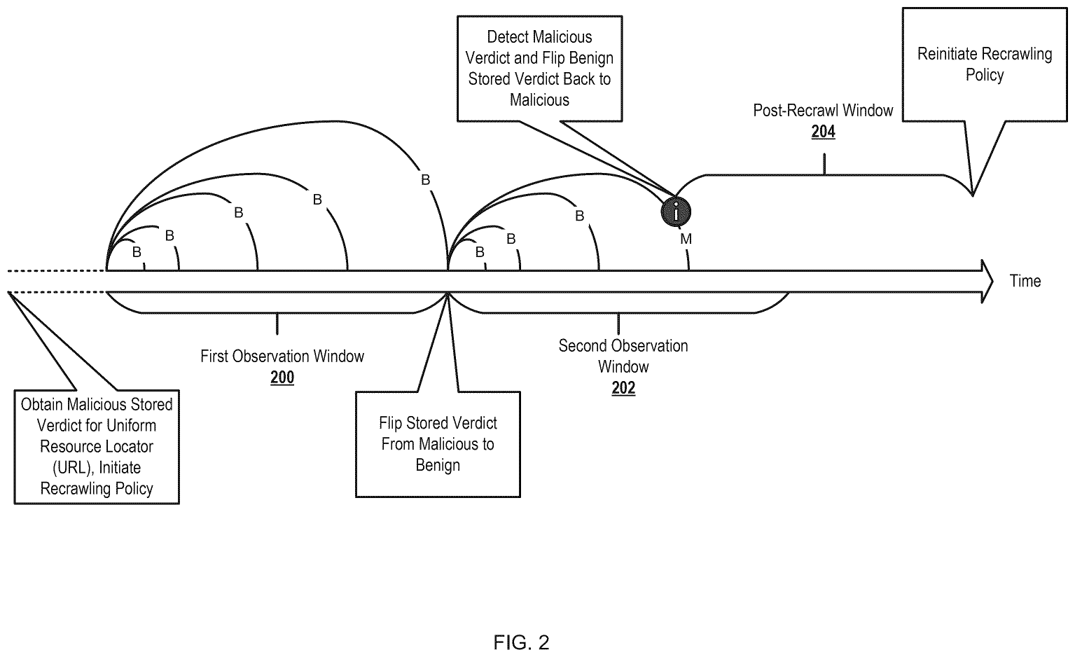

FIGS. 2-4 are illustrative diagrams of a stable verdict recrawling policy (e.g., the stable verdict recrawling policy 105 in FIG. 1) for various cases of when verdicts are flipped or maintained in the first and second observation windows as described in the foregoing. There is a dashed line at the beginning of the timelines in FIGS. 2-4 to indicates that there is an initial window (e.g., 30 days) subsequent to receiving a malicious stored verdict before initiating the stable verdict recrawling policy.

FIG. 2 is an illustrative diagram of applying a stable verdict recrawling policy when a malicious stored verdict is flipped to benign in a first observation window and flipped back to malicious in a second observation window. At the beginning of a first observation window 200, a malicious URL database receives a malicious stored verdict for a URL and enables the recrawling policy. In the first observation window 200, a web crawler recrawls the URL according to the recrawling policy and obtains verdicts for the URL. After five benign verdicts of the URL in the first observation window 200 that occur at successively more infrequent times, a flipping model determines that the URL is eligible for flipping. The flipping model then takes as input recrawling data from the first observation window 200 and outputs a verdict that indicates flipping the malicious stored verdict for the URL to benign. The malicious URL database disables the URL from URL filtering. In a second observation window 202 consecutive to the first observation window 200, the web crawler recrawls the URL according to the recrawling policy and obtains verdicts from the recrawling. Based on obtaining a malicious verdict after three benign verdicts, the web crawler immediately flips the verdict from benign to malicious and the malicious URL database reenables the URL. The web crawler then waits a post-recrawl window 204 prior to reinitiating the recrawling policy.

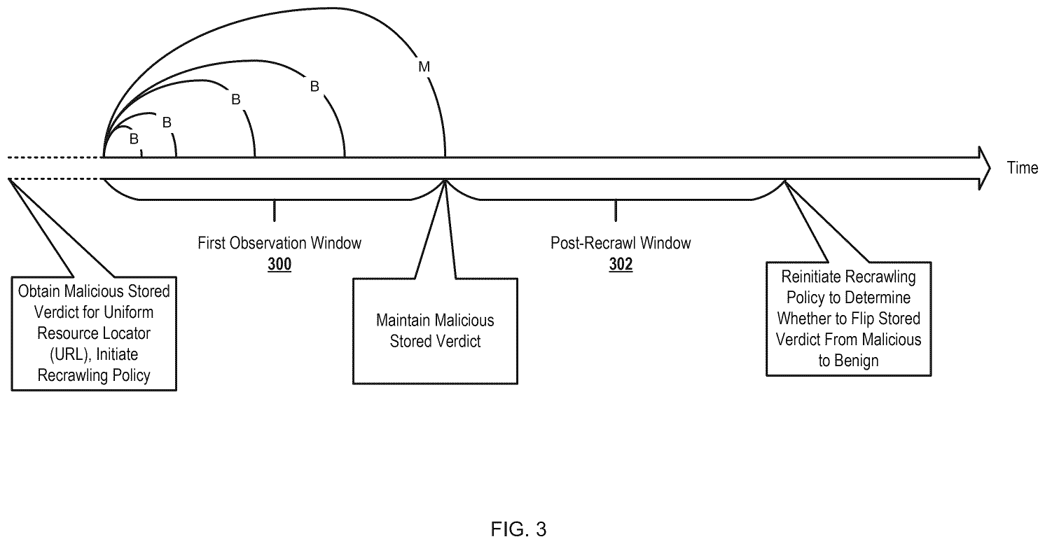

FIG. 3 is an illustrative diagram of applying a stable verdict recrawling policy when a malicious stored verdict is maintained in a first observation window. At the beginning of a first observation window 300, a malicious URL database receives a malicious stored verdict for a URL and enables the URL. In the first observation window 300, a web crawler recrawls the URL according to the recrawling policy at successively more infrequent times and obtains verdicts for the URL. After four benign verdicts and one malicious verdict for the URL in the first observation window 300, a flipping model determines that the URL is not eligible for flipping due to having too many malicious verdicts. The URL database maintains the malicious stored verdict for the URL and the web crawler waits a post-recrawl window 302 before reinitiating the recrawling policy. FIG. 3 depicts the malicious stored verdict being maintained after the first observation window 300 due to a malicious obtained verdict. Alternatively, if all the verdicts in the first observation window 300 are benign, the flipping model can take as input recrawling data from the first observation window 300 and output a verdict that indicates maintaining the malicious verdict. In both these cases the malicious stored verdict for the URL is maintained after the first observation window 300.

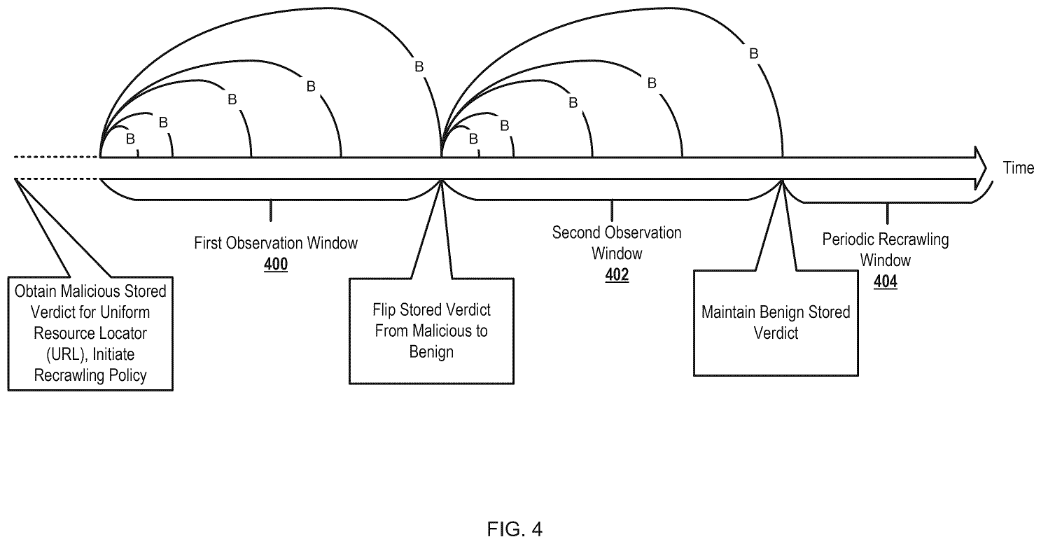

FIG. 4 is an illustrative diagram of applying a stable verdict recrawling policy when a malicious stored verdict is flipped to benign in a first observation window and the benign stored verdict is maintained in a second observation window. At the beginning of a first observation window 400, a malicious URL database obtains a malicious stored verdict for a URL and enables the URL. In the first observation window 400, a web crawler recrawls the URL according to the recrawling policy and obtains verdicts for the URL. After five benign verdicts of the URL in the first observation window 400 at times that are successively more infrequent, a flipping model determines that the URL is eligible for flipping. The flipping model then takes as input recrawling data from the first observation window 400 and outputs a verdict that indicates flipping the malicious stored verdict for the URL to benign. The malicious URL database then disables the URL from URL filtering. In a second observation window 402 consecutive to the first observation window 400, the web crawler recrawls the URL according to the recrawling policy and obtains verdicts from the recrawling. Based on obtaining all benign verdicts for the URL in the second observation window 402, the malicious URL database maintains the benign stored verdict. The web crawler then periodically recrawls the URL in a periodic recrawling window 404 to verify that the URL is still benign.

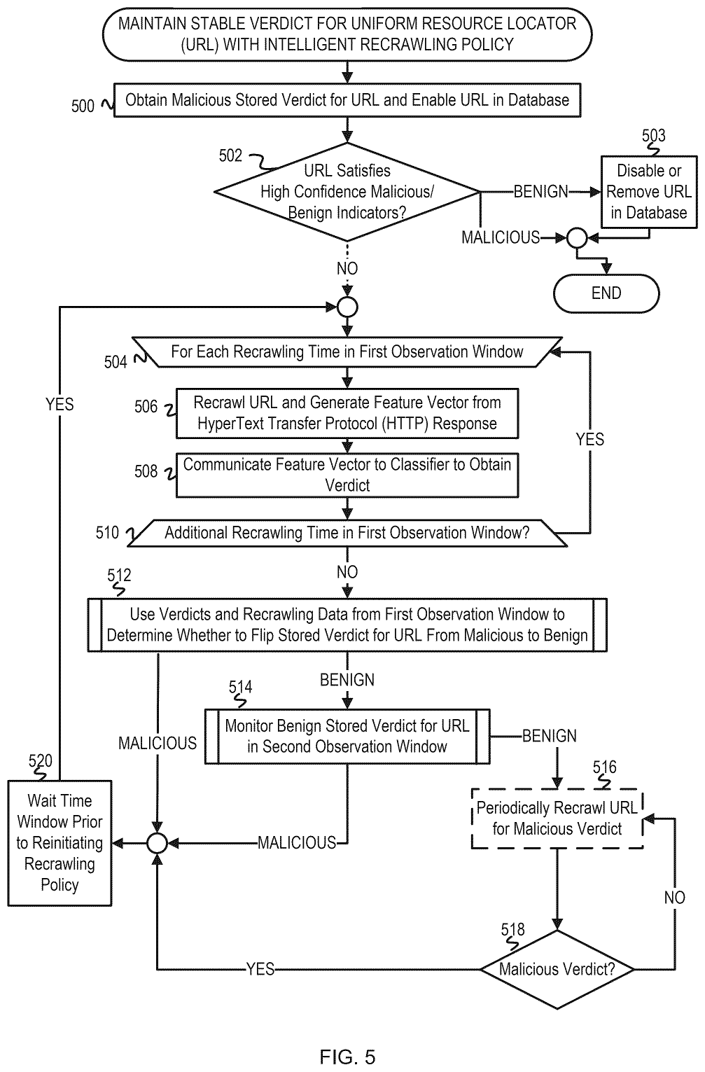

FIGS. 5-7 are flowcharts of example operations for maintaining a stable verdict for a URL with an intelligent recrawling policy. The example operations are described with reference to URL verdict flipping model (“flipping model”), a URL classification model (“classifier”), a malicious URL database (“database”), and a web crawler having a stable verdict recrawling policy (“recrawling policy”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 5 is a flowchart of example operations for maintaining a stable verdict for a URL with an intelligent recrawling policy. At block 500, the database obtains a malicious stored verdict for a URL and enables the URL in the database. The stored verdict comprises a verdict that is stored for URL filtering, for instance to filter URLs at a cloud firewall service. The malicious stored verdict can be obtained by the cloud firewall service, e.g., by detecting malicious activity associated with the URL, by classifying the URL according to third-party oracle sources of URLs, by inputting feature vectors for the URL into machine learning models maintained by the cloud firewall service, etc.

At block 502, the flipping model determines whether the URL satisfies high confidence malicious/benign indicators. The high confidence malicious indicators comprise indicators that are highly correlated with maliciousness of the URL and that exclude the URL from flipping its verdict from malicious to benign. The flipping model determines whether the URL satisfies the high confidence malicious/benign indicators according to metadata of the URL. For instance, for malicious indicators, the flipping model can determine that the URL corresponds to a web page having a suspicious category such as adult gambling or a vulnerable category such as web page having 404 HTTP response codes, an empty web page, a parked domain, etc. Additional high confidence malicious indicators include that the web page is associated with phishing according to a phishing detector. Benign indicators comprise an age of a domain for the URL, a time elapsed since the last change of registration, a stable Internet Protocol (IP) address, a number of known malicious children of the URL, etc. If the URL satisfies one or more of the high confidence malicious indicators, the operational flow in FIG. 5 stops and the URL is no longer considered for verdict flipping. If the URL satisfies one or more of the high confidence benign indicators, the database disables or removes the URL at block 503 and the operational flow in FIG. 5 stops. Otherwise, operational flow proceeds to block 504. There is a dashed line between blocks 502 and 504 to indicate that there is an initial window (e.g., 30 days) after obtaining a malicious stored verdict prior to initiating the recrawling policy. At block 504, the web crawler begins iterating through recrawling times in a first observation window according to the recrawling policy. The recrawling times are spaced out such that recrawling occurs more frequently towards the beginning of the first observation window and less frequently towards the end of the first observation window. For instance, for a first observation window of length 30 days, recrawls can occur at one day, two days, one week, two weeks, and 30 days. Other schedules for recrawling that are more frequent at the beginning of the first observation window and less frequent at the end are anticipated, for instance by varying how the frequency tapers, varying length of the observation window, etc. The schedules can be tuned based on available recrawling resources and can be configured by a user or organization of a cybersecurity system that oversees maintaining a stable verdict for the URL. Additionally, the schedules can depend on domain names in URLs, and different domains names can correspond to different schedules for the recrawling policy.

At block 506, the web crawler recrawls the URL and generates a feature vector based on an HTTP response from the recrawling. The web crawler can additionally retrieve verdicts and/or scores for the URL from one or more third-party sources to determine if those verdicts and/or scores have changed, and the feature vector can include the retrieved verdicts and/or scores.

At block 508, the web crawler communicates the feature vector to the classifier to obtain a verdict. As disclosed by the foregoing, the classifier comprises a classifier trained to generate initial malicious or benign verdicts of URLs. By contrast, the flipping model is trained to determine whether to flip an existing malicious verdict to a benign verdict.

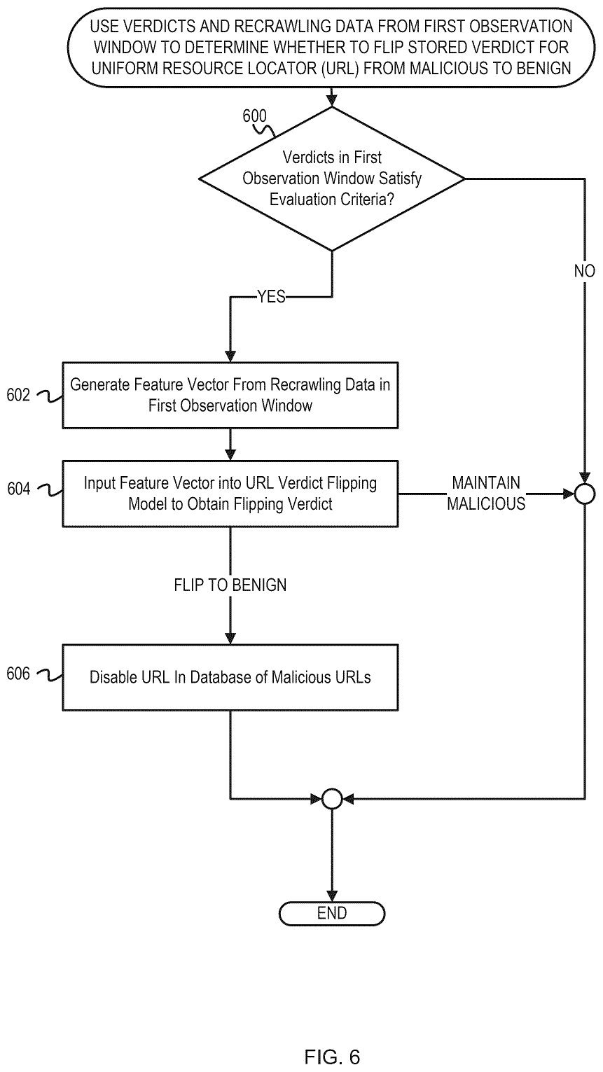

At block 510, the web crawler continues iterating over times in the first observation window. If there is an additional time in the first observation window, operational flow returns to block 504. Otherwise, operational flow proceeds to block 512. As described at block 600 in FIG. 6, the web crawler uses verdicts obtained in the first observation window to determine whether the URL is eligible for flipping. In some embodiments, this determination is made subsequent to block 508 at iterations of recrawling. For these embodiments, if, during recrawling in the first observation window, the web crawler determines based on the verdicts that the URL is not eligible for flipping (based on evaluation criteria described below), operational flow can skip from block 508 at that iteration to block 520.

At block 512, the flipping model uses the verdicts and recrawling data from the first observation window to determine whether to flip the stored verdict for the URL from malicious to benign. The flipping model first applies evaluation criteria to the verdicts to determine whether the URL is eligible for flipping the stored verdict. If the URL is eligible, the flipping model then receives a feature vector from the recrawling data as input to output a verdict that indicates whether to flip the stored verdict for the URL from malicious to benign. The operations at block 512 are described in greater detail in reference to FIG. 6. If the flipping model verdict indicates flipping the stored verdict from malicious to benign, operational flow proceeds to block 514. Otherwise, if the flipping model verdict indicates to maintain the stored verdict as malicious, operational flow proceeds to block 520.

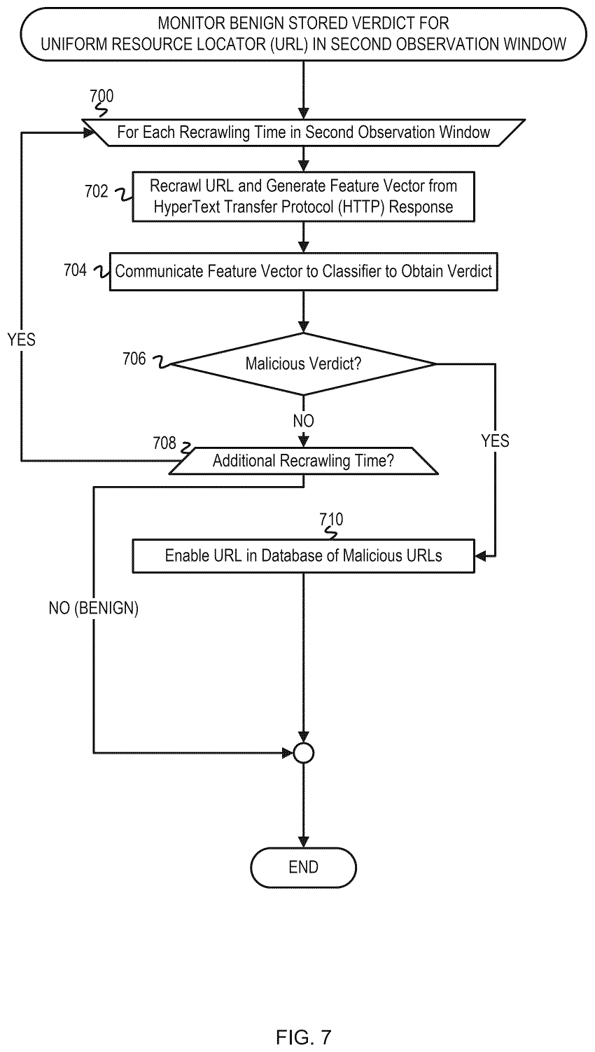

At block 514, the web crawler recrawls the URL in a second observation window and communicates recrawling data to the classifier to obtain verdicts that monitor the benign stored verdict for the URL in the second observation window. The operations at block 514 are described in greater detail in reference to FIG. 7. If the benign stored verdict is maintained after the second observation window, operational flow proceeds to block 516. Otherwise, if the benign stored verdict is flipped to malicious after the second observation window, operational flow proceeds to block 520.

At block 516, the web crawler periodically recrawls the URL for a malicious verdict. The periodic recrawling can be less frequent than recrawling during the first and second observation windows (e.g., every 30 days). The web crawler generates feature vectors from recrawling data and communicates the feature vectors to the classifier to obtain additional verdicts at each time in the recrawling. Block 516 is depicted with a dashed outline to indicate that periodic recrawling occurs until an external trigger (e.g., an administrator of the recrawling policy and/or associated cloud firewall service turning off monitoring of the URL) occurs.

At block 518, when a verdict is obtained from periodically recrawling the URL, the web crawler determines whether the verdict is malicious. If a malicious verdict is obtained, operational flow proceeds to block 520. Otherwise, operational flow returns to block 516 for additional periodic recrawling.

At block 520, the web crawler waits for a time window (e.g., 30 days) prior to reinitiating the recrawling policy. The web crawler waits for the time window to reduce resources used for recrawling because the URL is more likely to still be malicious in a time window after the last malicious verdict occurred. Each of the operational flows into block 520 from blocks 512, 514, and 518 corresponds to a malicious verdict. In some embodiments, the time window for waiting can have varying lengths depending on which of the blocks 512, 514, 518 generated the malicious verdict.

FIG. 6 is a flowchart of example operations for using verdicts and recrawling data from a first observation window to determine whether to flip a stored verdict for a URL from malicious to benign. The verdicts and recrawling data were obtained from recrawling the URL and (optionally) third-party sources maintaining maliciousness data for the URL during the first observation window.

At block 600, the flipping model determines whether the verdicts in the first observation window satisfy evaluation criteria. The evaluation criteria determine whether the malicious stored verdict for the URL is considered for flipping from malicious to benign. As an example, the evaluation criteria can indicate that all of the verdicts in the first observation window are benign or that a threshold number/percentage of the verdicts in the first observation window are benign. If the verdicts in the first observation window satisfy the evaluation criteria, operational flow proceeds to block 602. Otherwise, the malicious stored verdict is maintained for the URL and the operational flow in FIG. 6 stops.

At block 602, the web crawler generates a feature vector from combining the recrawling data in the first observation window. Values in the feature vector can comprise a number of malicious hyperlinks in a web page for the URL, a content size for the web page, a number of documents and/or scripts in the web page, a number of IP addresses that serve a main web page for the URL, third-party scores for the web page, etc. These values can be generated from recrawling data for each time the URL was recrawled in the first observation window. In some instances, values of a feature can be averages or otherwise aggregated across recrawling instances when generating the feature vector.

At block 604, the web crawler inputs the feature vector into the flipping model to obtain a flipping verdict. The flipping verdict indicates whether to flip the stored verdict for the URL from malicious to benign. As described in the foregoing, the flipping model was trained on feature vectors for recrawled data of URLs having initial malicious stored verdicts in observation windows and corresponding ground truth verdicts that indicate whether the URLs maintained their malicious status or switched from malicious to benign during the observation windows. The flipping model can comprise a machine learning classifier such as a gradient boosting model, a random forest model, a support vector machine, a neural network classifier, etc. If the flipping verdict indicates flipping the stored verdict for the URL from malicious to benign, operational flow proceeds to block 606. Otherwise, the malicious stored verdict for the URL is maintained and the operational flow in FIG. 6 stops.

At block 606, the database disables the URL. The database can maintain the URL in memory in case the stored URL for the verdict subsequently flips from benign back to malicious. The database can be a database used by a URL filtering service.

FIG. 7 is a flowchart of example operations for monitoring a benign stored verdict for a URL in a second observation window. The URL has a benign stored verdict that was flipped from malicious to benign in a first observation window prior to the second observation window. The URL is subjected to additional observation in the second observation window to verify that the flipped benign verdict maintains stability.

At block 700, the web crawler begins iterating through times in the second observation window. The times in the second observation window can be more frequent at the beginning of the second observation window and less frequent at the end of the second observation window, with frequency incrementally declining throughout the second observation window.

At blocks 702 and 704, the web crawler recrawls the URL at the time in the second observation window, generates a feature vector from a corresponding HTTP response, and communicates the generated feature vector to the classifier to obtain a verdict for the URL. The operations at blocks 702 and 704 are substantially similar to operations blocks 506 and 508 in reference to FIG. 5.

At block 706, the web crawler determines whether the obtained verdict is malicious. In contrast with the first observation window where flipping was based on verdicts obtained throughout the first observation window and a subsequent flipping verdict by the flipping model, flipping the verdict from benign to malicious in the second observation window is based on a single malicious verdict by the classifier. Moreover, the flipping model is more stringent in generating verdicts that flip the stored verdict than the classifier. If the obtained verdict is malicious, operational flow proceeds to block 710. Otherwise, operational flow proceeds to block 708.

At block 708, the web crawler determines whether there is an additional time in the second observational window. If there is an additional time, operational flow returns to block 700. Otherwise, the benign stored verdict for the URL is maintained after the second observational window, and the operational flow in FIG. 7 stops.

At block 710, the database enables the URL. The database can additionally populate any additional data obtained from verdicts such as a category of the URL, a severity score for the URL, etc.

### Variations

The foregoing description refers to a web crawler as receiving verdicts from a URL classification model and a URL verdict flipping model and using those verdicts to guide a stable verdict recrawling policy for a URL. These operations can alternatively be performed by a separate component built on top of the web crawler that sends instructions to the web crawler to initialize and update its recrawling policy for the URL. Any of the operations for recrawling with the stable verdict recrawling policy can be separate from an existing crawling policy running at the web crawler for URLs not having malicious stored verdicts.

Any of the foregoing web crawlers and flipping models can be applied across multiple URLs for a URL filtering service. The web crawler can manage multiple instances of a stable verdict recrawling policy within its crawling policy and can operate in tandem with the flipping model as URLs for the URL filtering service are recrawled.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 600 can be omitted and the flipping model can make a determination for whether to flip the stored malicious verdict regardless of whether the verdicts in the first observation window satisfy the evaluation criteria. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platforms (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

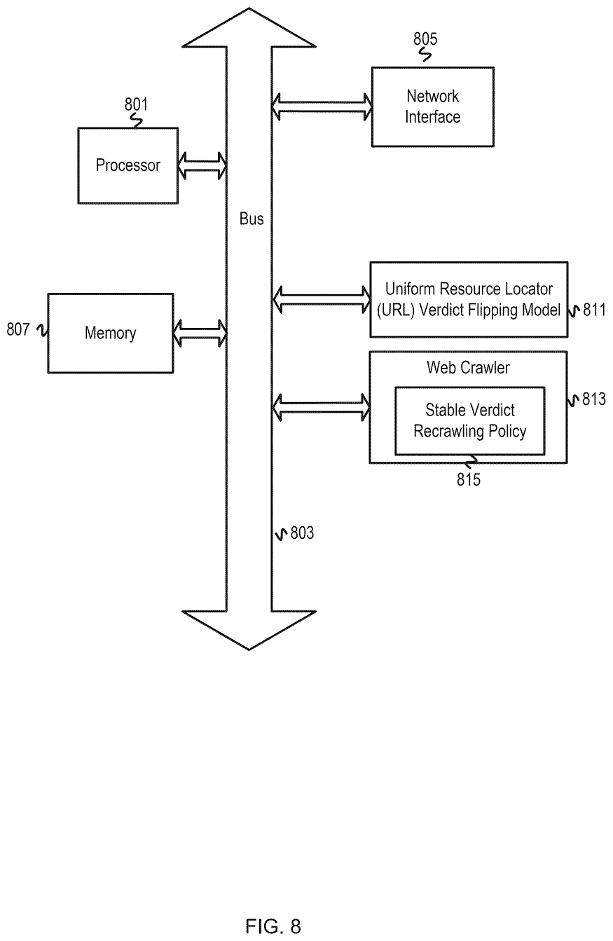

FIG. 8 depicts an example computer system with a URL flipping model and a web crawling having a stable verdict recrawling policy. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a URL flipping model (“flipping model”) 811 and a web crawler 813 that comprises a stable verdict recrawling policy (“recrawling policy”) 815. Based on obtaining a malicious stored verdict for a URL, the web crawler 813 recrawls the URL according to the recrawling policy 815. The recrawling policy specifies a first observation time window for performing n recrawls of a URL to obtain n more verdicts after the initial malicious verdict. The recrawling policy 815 can also specify increasing intervals between recrawls to taper the recrawling resource consumption while continuing to obtain data to inform a flipping determination. Implementations can vary as to the extent and magnitude of tapering. After expiration of the first observation time window, the web crawler 813 evaluates the n verdicts against criteria indicative of verdict stability. If the verdicts satisfy this evaluation criteria, the flipping model 811 is invoked to output a verdict indicating whether to flip the stored verdict based on the n verdicts and metadata corresponding to the n verdicts. If the verdict output by the flipping model 811 indicates flipping, the stored verdict is flipped from malicious to benign. If a stored verdict for a URL is flipped from malicious to benign, then a second observation time window in the recrawling policy 815 is triggered to validate the flipping. In the second observation time window, the web crawler 813 recrawls the URL to obtain additional verdicts at recrawl intervals as specified in the recrawling policy 815 to validate or reverse the flipping. If the web crawler 813 obtains a malicious verdict for the URL during the second observation time window, the web crawler 813 flips the stored verdict for the URL from benign back to malicious. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

1. A method comprising:
based on obtaining a stored verdict for a uniform resource locator (URL) indicating that the URL is malicious, initiating a recrawling policy for the URL to maintain stability of the stored verdict for the URL;
recrawling the URL at each time for recrawling the URL in a first time window according to the recrawling policy to retrieve first recrawling data;
obtaining first verdicts for the URL based, at least in part, on the first recrawling data; and
based on the first verdicts satisfying evaluation criteria, inputting one or more feature vectors of the first recrawling data into a trained model to obtain a flipping verdict as output, wherein the flipping verdict indicates whether to flip the stored verdict from malicious to benign after the first time window.

2. The method of claim 1, wherein the evaluation criteria comprise that a number of benign verdicts in the first verdicts is above a first threshold.

3. The method of claim 1, further comprising flipping the stored verdict for the URL from malicious to benign based on corresponding indications in the flipping verdict.

4. The method of claim 3, further comprising:
recrawling the URL at each time for recrawling the URL in a second time window according to the recrawling policy to obtain second recrawling data;
obtaining second verdicts for the URL based, at least in part, on the second recrawling data; and
based on obtaining a malicious verdict in the second verdicts during the recrawling in the second time window, flipping the stored verdict from benign to malicious.

5. The method of claim 4, wherein the times for recrawling in the first time window and in the second time window according to the recrawling policy are successively more infrequent in each time window.

6. The method of claim 4, further comprising restarting the recrawling policy after a third time window subsequent to the second time window has elapsed.

7. The method of claim 3, wherein flipping the stored verdict for the URL from malicious to benign comprises disabling the stored verdict for the URL in a database.

8. The method of claim 1, wherein the trained model comprises a machine learning model trained on recrawling data for URLs in time windows and indications of whether corresponding ground truth verdicts flipped from malicious to benign in the time windows.

9. The method of claim 1, wherein the first recrawling data comprises at least one of malicious hyperlinks in a web page of the URL, a number of Internet Protocol (IP) address sources for the web page, a length of content in the web page, a number of documents in the web page, a number of scripts in the web page, and a third-party security score for the URL.

10. The method of claim 1, further comprising, prior to initiating the recrawling policy, determining that the URL does not satisfy high confidence criteria for a malicious verdict.

11. A non-transitory machine-readable medium having program code stored thereon, the program code comprising instructions to:
based on obtaining a stored verdict for a uniform resource locator (URL) indicating that the URL is malicious, recrawl the URL n times in a first time window according to a recrawling policy, wherein the recrawling policy specifies n and time intervals between recrawls in the first time window;
obtain first verdicts for the URL based, at least in part, on first recrawling data of the recrawls in the first time window;
determine whether evaluation criterion for potentially flipping the stored verdict is satisfied based, at least in part, on the first verdicts and the first recrawling data; and
based on a determination that the evaluation criterion is satisfied, invoke a trained model to obtain a flipping verdict based on the first data, wherein the flipping verdict indicates whether to flip the stored verdict from malicious to benign.

12. The non-transitory machine-readable medium of claim 11, wherein the evaluation criteria specify a threshold of benign verdicts.

13. The non-transitory machine-readable medium of claim 11, wherein the program code further comprises instructions to flip the stored verdict for the URL from malicious to benign based on the flipping verdict.

14. The non-transitory machine-readable medium of claim 11, wherein the program code further comprises instructions to:
based on the stored verdict for the URL being flipped from malicious to benign, recrawl the URL until the earlier of a second time window expires or a malicious verdict is obtained from recrawling the URL in the second time window, wherein the recrawling policy specifies duration of the second time window and one or more time intervals between recrawls in the second time window;
for each recrawl of the URL in the second time window,
obtain a verdict for the URL based, at least in part, on second recrawling data generated from recrawling the URL in the second time window;
determine whether the verdict of the URL in the second time window is a malicious verdict; and
based on the verdict of the URL in the second time window being a malicious verdict, flip the stored verdict from benign to malicious.

15. The non-transitory machine-readable medium of claim 11, wherein a later of the time intervals for recrawling in the first time window is greater than an earlier of the time intervals in the first time window.

16. An apparatus comprising:
a processor; and
a machine-readable medium having instructions stored thereon that are executable by the processor to cause the apparatus to,
based on obtaining a stored verdict for a uniform resource locator (URL) indicating that the URL is malicious, initiate a recrawling policy for the URL to maintain stability of the stored verdict for the URL;
recrawl the URL at each time for recrawling the URL in a first time window according to the recrawling policy to retrieve first recrawling data;
obtain first verdicts for the URL based, at least in part, on the first recrawling data;
determine that the first verdicts satisfy criteria for eligibility of flipping the stored verdict; and
input one or more feature vectors of the first recrawling data to obtain a flipping verdict as output, wherein the flipping verdict indicates whether to flip the stored verdict from malicious to benign after the first time window.

17. The apparatus of claim 16, wherein the criteria comprise that a number of benign verdicts in the first verdicts is above a first threshold.

18. The apparatus of claim 16, wherein the machine-readable medium further has stored thereon instructions executable by the processor to cause the apparatus to flip the stored verdict for the URL from malicious to benign based on corresponding indications in the flipping verdict.

19. The apparatus of claim 18, wherein the machine-readable medium further has stored thereon instructions executable by the processor to cause the apparatus to:
recrawl the URL at each time for recrawling the URL in a second time window according to the recrawling policy to obtain second recrawling data;
obtain second verdicts for the URL based, at least in part, on the second recrawling data; and
based on obtaining a malicious verdict in the second verdicts during the recrawling in the second time window, flip the stored verdict from benign to malicious.

20. The apparatus of claim 19, wherein the times for recrawling in the first time window and in the second time window according to the recrawling policy are successively more infrequent in each time window.
